(19) United States
(12) Patent Application Publication
(10) Pub. No.: US 2008/0166688 A1
(43) Pub. Date: Jul. 10, 2008

(54) 60 In 6 effective writing

(76) Inventor: Alan Richman, Morganville, NJ (US)

Correspondence Address: Charles I. Brodsky, 2 Bucks Lane, Marlboro, NJ, 07746, US

(21) Appl. No.: 11/999,283

(22) Filed: Dec. 6, 2007

Related U.S. Application Data
(60) Provisional application No. 60/878,704, filed on Jan. 5, 2007.

(51) Int. Cl. G09B 19/00

(52) U.S. Cl. 434/156

(57) ABSTRACT

By utilizing the worksheets of the invention to write sixty words in six minutes according to its teachings, utilizing the Who-What-When-Where-Why-How six word writing concept, a method to overcome one's fear of writing and to express feelings, knowledge and concerns in a manner to give personal satisfaction is described.

### CROSS-REFERENCE TO RELATED APPLICATIONS

A Provisional Patent Application covering the invention described herein was filed Jan. 5, 2007, and assigned Ser. No. 60/878,704.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not applicable

### BACKGROUND OF THE INVENTION

1. Field of the Invention

This invention relates to a method to improve one's writing ability and written expression, in general, and to a method of accomplishing this through a utilization of the Who-What-When-Where-Why-How concept recognized and promoted in the writing profession.

2. Description of the Related Art

It is widely accepted that good writing is largely a matter of motivation and editing. In like fashion, unless one is writing purely for the joy of self-expression, it is likely that he/she wants the writing to have some sort of effect in the real world. In other words, people want their writings to be not merely “good”, but effective as well. As will be understood, many books have been written, and seminars given on such topics as “What motivates people to write well?” and “What skills are needed to polish one's writing?”.

Essentially, it is accepted that an effective writing is one that has a logical flow of ideas and is cohesive. Also, the ideas to be understood need to be clearly expressed in a logical text that is easy to follow. With links established between and within sentences, paragraphs and sections, the writing then becomes easy to follow, using language to maintain the writer's focus and to direct the reader.

But, why do people write to begin with? Usually, to convey information, to file complaints, to impress others, to solidify their own ideas, to preserve something of themselves for posterity, to change other's behavior, to make money, etc. However, not everyone writes.

So why don't people write? Primarily, because of a fear that they cannot, fear of their being censured or ridiculed, fear of their failing, fear that it will take too much time, fear that they will have nothing significant to say, fear that they cannot spell or don't have a firm enough grasp on grammar, etc.

Many techniques have been suggested—oftentimes revolving around the organizing of one's thoughts using an outline. Promoted for the general purpose of aiding in the process of writing, the development of these outlines is urged as an assist to help one organize ideas, to present the material in a logical form, to construct an ordered overview of the writing—and, in general, to show the relationship among the ideas being advanced. The making of these outlines are frequently advised, for example, to avoid the possibility that the information described would be scattered, or without focus.

But even recognizing the benefits of “outlining”, the barrier of fear to the writing continues at hand.

### SUMMARY OF THE INVENTION

As will become clear. The present invention offers a technique to overcome one's fear of writing and to express feelings, knowledge and concerns in a manner that will not only give personal satisfaction, but will earn the respect of friends, colleagues, employers, and the reading public. Regardless of whether one is asked to pen a thank you note, a novel, a speech or business plan, a term paper or essay, a love letter or business report, the technique of the invention will be seen to provide the tool to conquer the assignment and accomplish the goal without worry or hesitation. By writing 60 words in 6 minutes according to the teachings of the invention, even the densest writer's block can be broken—whether the writing be directed towards E-mails, Memos, Letters, Diaries, Instructions and Directions, Birth/Graduation/Engagement/Wedding Announcements, Press Releases, Classified Ads, Display Ads, Reports, Articles or more. And, as will be understood, the technique will be seen to be applicable, whether presented in “book” form or at localized seminars.

In particular, a Who-What-When-Where-Why-How six word concept is utilized.

### BRIEF DESCRIPTION OF THE DRAWINGS

These and other features of the present invention will be more clearly understood from a consideration of the following description, taken in connection with the accompanying drawings, in which:

FIG. 1 shows a worksheet useful in teaching the writing technique of the invention;

FIG. 2 shows the worksheet as it may be used to prepare an obituary;

FIG. 3 shows the worksheet of the invention used for writing computer instructions; and

FIG. 4 shows the worksheet of the invention as it might be employed in the writing of a Film Review—but, inadvertently, incomplete as far as one facet of the invention is concerned.

### DETAILED DESCRIPTION OF THE INVENTION

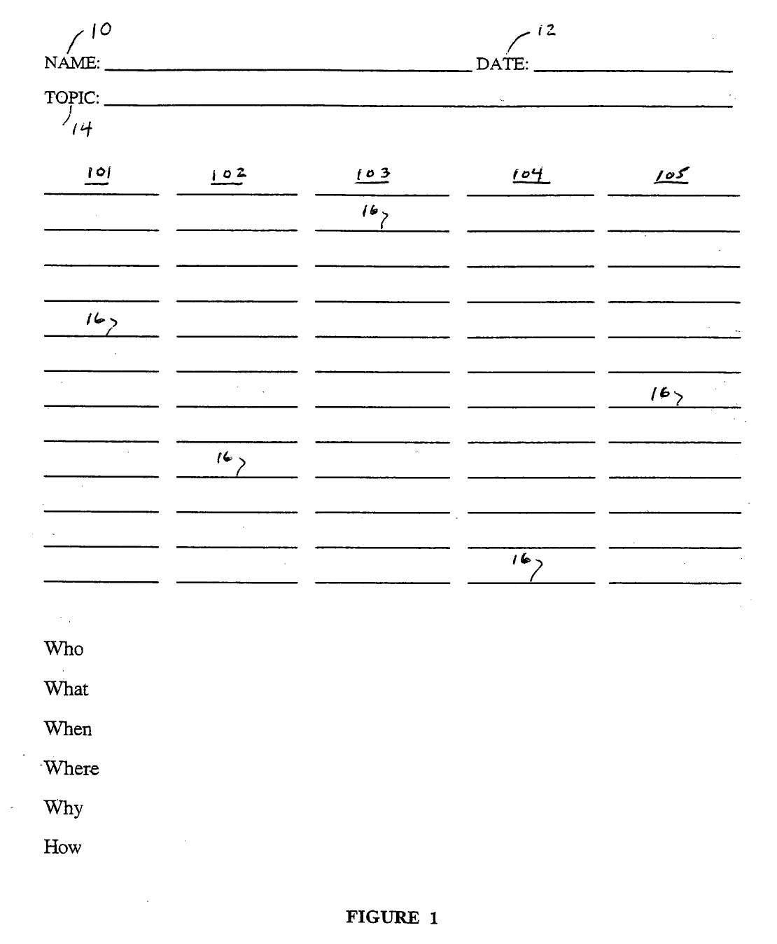

In the worksheet shown in FIG. 1 for teaching the writing technique, space is provided for insertion of the writer's name 10, the date of the writing 12 and the topic at hand 14. In this example, five columns are set out (101-105), with areas for the insertion of twelve words per column, as at 16, for a total of sixty words. Below Column 101, for example, in descending order, are the words: Who, What, When, Where, Why and How.

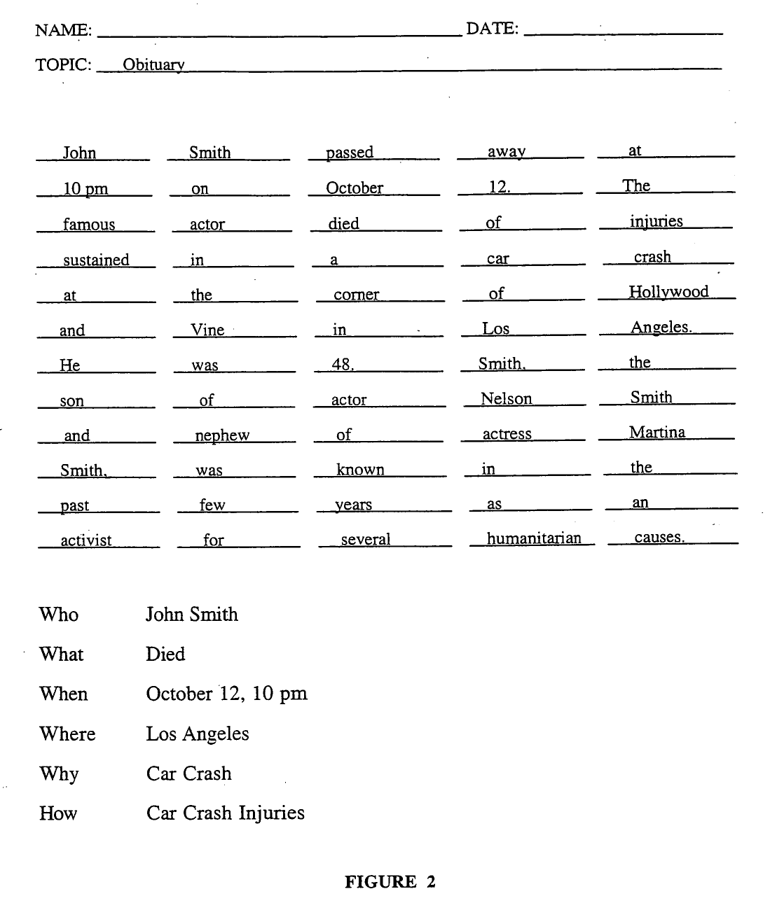

The obituary worksheet illustrated in FIG. 2 deals with the Who-What-When-Where-Why-How 6 word circumstances dealing with the death of a John Smith, who died October 12th at 10:00 p.m. in Los Angeles from injuries sustained in a car crash.

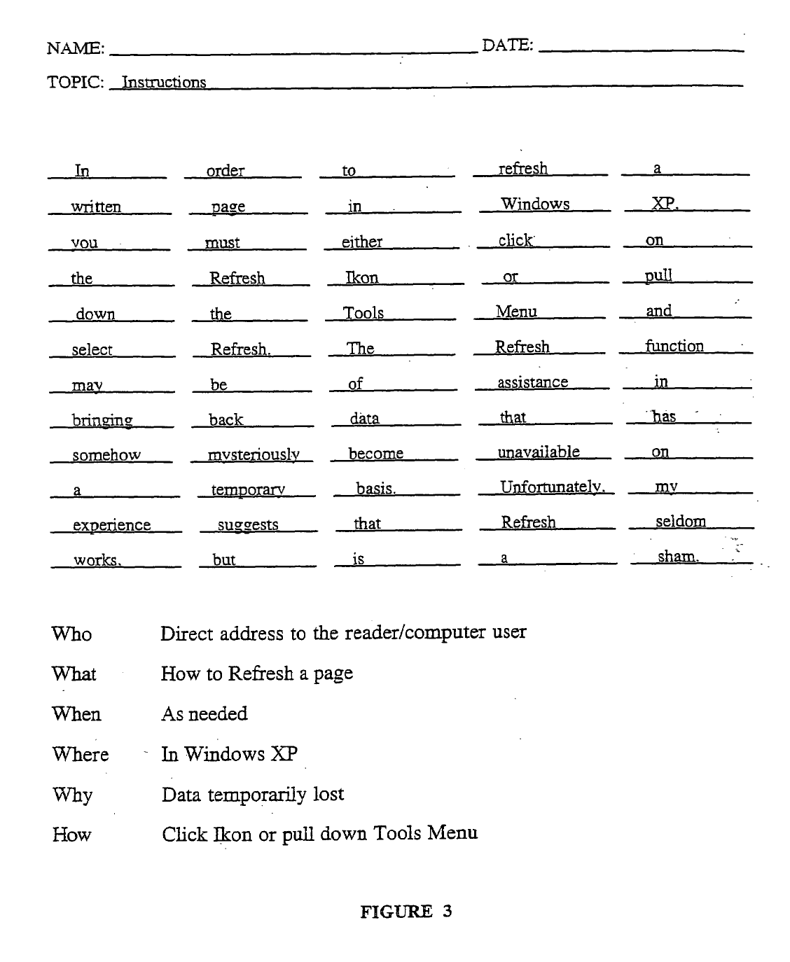

FIG. 3 shows the worksheet writing of the Who-What-When-Where-Why-How concept of the invention for a computer instruction for directing access to the reader/computer user in refreshing a page in Windows XP as needed, where data is temporarily lot through the clicking of an icon or the pulling down of a Tools Menu.

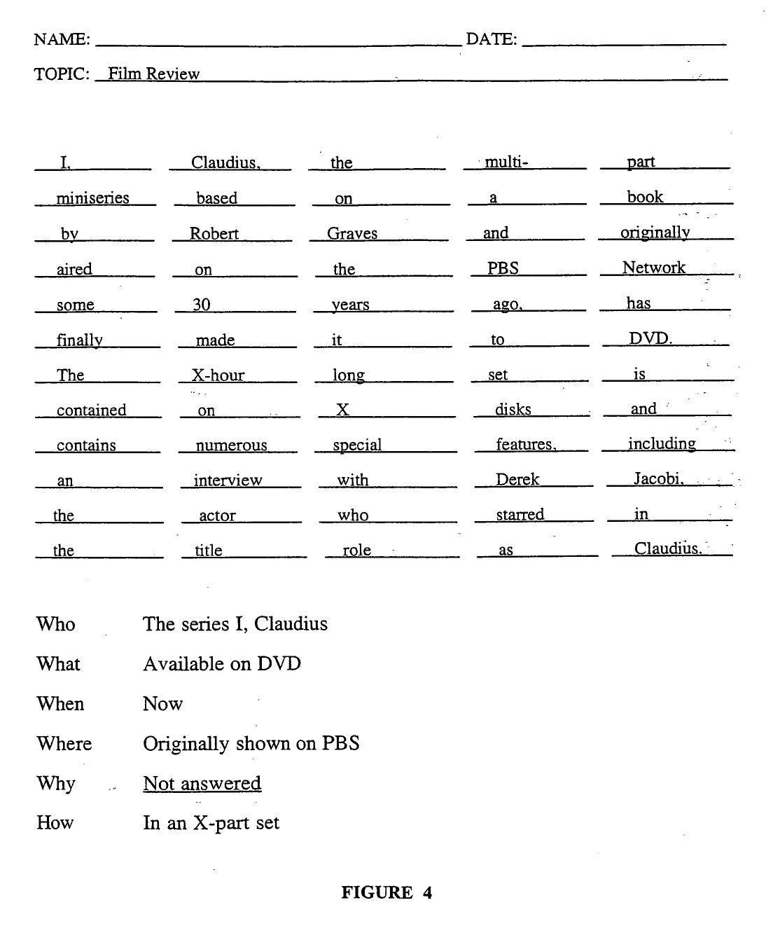

FIG. 4 shows the worksheet for the Who-What-When-Where-Why-How concept for writing a Film Review for the series I, Claudius, available at present on DVD as originally shown on PBS in a 10-Part Set, but with the “Why” information inadvertently omitted.

In accordance with the method of the invention, the writer is instructed to cover the six words of Who-What-When-Where-Why-How concept within six minutes, by inserting one word in each of the areas 16 of each of the five columns while covering the subject matter at hand. Beginning with something familiar, non-threatening and common as in the illustratively filled-in worksheet of FIG. 2, a realization is reached that the fear of writing can be diminished, and the ability to effectively convey information can be enhanced. Starting from such a rudimentary set of facts, as in FIG. 2, and then elevating to additional sets which are more complete, has been found to point not only to a confidence in presenting the writings, but to an ability to get the information across to a reader of it more effectively. In accordance with a preferred embodiment of the invention, five columns of twelve one-word areas each leads to the insertion of these sixty words—such that when eventually done in the six minute time frame, a breakthrough of the fear barrier can be had through short, easy sentence exercises. The exercise illustrated by the FIG. 2 worksheet represents a 60 word writing based on a short scenario, well accomplishable within the 6 minute time frame. (In this worksheet, the scenario consists of only six facts.)

In similar fashion, the worksheet of FIG. 3 also is based on a scenario of six facts, giving rise to the writing, once again, of sixty words in the five columns and in the 12 areas per column to cover all of the factual material—one word per area space. Although somewhat more complex than the worksheet of FIG. 2, the technique provides the tools to overcome the fear of writing and to convey the knowledge in a meaningful way.

In the FIG. 4 worksheet, however, the evaluator of the writing would recognize that while the Who-What-When-Where and How concept words have been provided in the writing, the “Why” concept has not been dealt with. Evaluation by a seminar lecturer, for example, can point this out. And, reviewing the FIG. 4 worksheet scenario, different areas for further writing could be suggested in dealing with such other issues in the Film Review as to: a) The quality of the acting; b) The quality of the writing; c) The appearance of visuals; d) The impact of the performance; e) The history of the performance; or f) The controversial nature of the film when first aired. With that, any further writing could be analyzed and evaluated in like manner through a further writing of sixty words in six minutes in the 60 columnar area spaces provided. Starting from a rudimentary set of facts in this manner, and then elevating to another set which is more complete, has been analyzed to lead to a confidence of the writer in presenting his/her writings, at the same time as leading to an ability to get the information across to a reader more effectively.

While there have been described what are considered to be preferred embodiment of the present invention, it will be readily appreciated by those skilled in the art that modifications can be made without departing from the scope of the teachings herein. For example, while the method of the invention has been described in the context of employing 5 columns of 12 rows each for the insertion of one word per area, it will be apparent that 6 columns of 10 rows each, or 4 columns of 15 rows each, or 10 columns of 6 words each, can be employed instead in teaching the 60 words in 6 minutes technique, one per area, utilizing and encompassing the Who, What, When, Where, Why, How coverage concept of inclusive writing. For at least such reason, therefore, resort should be had to the claims appended hereto for a true understanding of the scope of the invention, recognizing that the insertion of the individual words within the areas provided could be accomplished by pen, pencil, typewriter, or computer keyboard, depending upon the media in which the worksheet of the invention is presented.

I claim:

1. A method to enhance writing ability and written expression comprising the steps of:
providing a worksheet of 60 individual space areas arranged in columns and rows;
directing the written insertion of one word in each individual space area to fill said worksheet;
directing the written insertion of all 60 words to be completed within 6 minutes; and
directing the insertion of said 60 words to encompass the Who, What, When, Where, Why, How coverage concept of inclusive writing.

2. The method of claim 1 wherein the written insertion of one word in each individual space area is directed to be done by one of pen, pencil, typewriter and computer keyboard.

3. The method of claim 2 wherein said worksheet is provided of 60 individual space areas arranged in one of 4 columns of 15 individual space areas each, 5 columns of 12 individual space areas each, 6 columns of 10 individual space areas each and 10 columns of 6 individual space areas each.

4. The method of claim 3 wherein said worksheet is provided of 60 individual space areas arranged in 5 columns of 12 individual space areas each.

5. The method of claim 1 also including the step of analyzing the written insertion of all 60 words inserted in a worksheet to evaluate the coverage compliance of the 60 words with the Who, What, When, Where, Why, How concept of inclusive writing.
